(19) United States
(12) Patent Application Publication
(10) Pub. No.: US 2016/0019481 A1
(43) Pub. Date: Jan. 21, 2016

(54) Customer Relationship Capacity Planning

(71) Applicant: FMR LLC, Boston, MA (US)

(72) Inventor: Bidhan Roy, Karnataka (IN)

(21) Appl. No.: 14/332,283

(22) Filed: Jul. 15, 2014

(51) Int. Cl. G06Q 10/06; G06Q 30/00

(52) U.S. Cl. CPC G06Q 10/0639; G06Q 30/01

(57) ABSTRACT

Methods and apparatuses, including computer program products, are described for customer relationship capacity planning. A computing device receives (i) financial plan attributes associated with a financial plan of a customer and (ii) personality characteristics associated with the customer. The computing device determines a relationship complexity score associated with the customer based upon the financial plan attributes and the personality characteristics. The computing device determines a target workload value for customer service managers of the financial services entity based upon the relationship complexity score for a plurality of customers and a past number of relationship service hours associated with the plurality of customers. The computing device allocates the customer to a customer service manager based upon the target workload value and a current workload of the customer service manager. The computing device updates an allocation table that contains information relating to the allocation of customers to customer service managers.

### FIELD OF THE INVENTION

This application relates generally to methods and apparatuses, including computer program products, for customer relationship capacity planning.

### BACKGROUND

Typically, financial services entities and other service organizations have a large number of customer relationships of varying scope and complexity. Customer service managers (CSMs) at the financial services entity are each tasked with managing a set of customer relationships and providing service to the set of customers.

Traditionally, the allocation of customers to CSMs has been done using a subjective approach (i.e., CSM 1 seems capable of managing the customer relationship with Customer X) without regard to the specific needs and complex nature of either the incoming customer relationship or the CSM's current customer relationships. Another approach to allocating customers to CSMs has been a neutral approach, essentially dividing the number of customers by the number of CSMs without regard to any evaluation of capacity or relationship complexity. Both of the aforementioned approaches can result in overworked CSMs, customers that are not receiving an appropriate or necessary level of customer service, and inefficient allocation of CSM resources by the financial services entity.

### SUMMARY OF THE INVENTION

Therefore, methods and systems for customer relationship capacity planning are needed that take into account the complexity of the customer relationship for each individual customer, as well as the current and future capacity of customer service managers to handle their allocated customer relationships. The methods and systems described herein provide the advantage of analyzing the customer relationship with the financial services entity, both from the perspective of the scope and features of the services provided by the entity to the customer and the perspective of the personality profile of the customer (e.g., what type and level of service does the customer desire). As an example, call center environments typically operate in terms of the life of a call, that is, every call is considered a discrete entity and can be closed once the call is complete. Similarly, back office environments typically operate in terms of the life of a transaction or workflow. However, in customer relationship management environments; the focus is not on length of relationship time. Instead, the goal is for a customer relationship to be perpetual—once a client is on board, a company strives to ensure the client stays on board.

The methods and systems described herein also provide the advantage of dynamically evaluating and adjusting the current workload for a CSM to ensure an appropriate level of relationship complexity is assigned to each CSM and also to identify top performers for incoming customer service relationships. This objective assessment can be used by company management as an additional metric in determining performance ratings of customer service agents. The techniques described herein also assist in identifying best practices in the relationship operations domain and determining training needs of the customer service agents—which results in better customer service.

The invention, in one aspect, features a computerized method for customer relationship capacity planning by a financial services entity. A computing device receives (i) financial plan attributes associated with a financial plan of a customer, where the financial plan attributes relate to scope of assets and feature set of the financial plan, and (ii) personality characteristics associated with the customer, where the personality characteristics relate to level of interaction required by the customer and structure of the customer's employees. The computing device determines a relationship complexity score associated with the customer based upon the financial plan attributes and the personality characteristics. The computing device determines a target workload value for customer service managers of the financial services entity based upon the relationship complexity score for a plurality of customers and a past number of relationship service hours associated with the plurality of customers, the target workload value representing a level of effort from the financial services entity to provide service to the plurality of customers. The computing device allocates the customer to a customer service manager based upon the target workload value and a current workload of the customer service manager. The computing device updates an allocation table that contains information relating to the allocation of customers to customer service managers.

The invention, in another aspect, features a system for customer relationship capacity planning by a financial services entity. The system includes a computing device configured to receive (i) financial plan attributes associated with a financial plan of a customer, where the financial plan attributes relate to scope of assets and feature set of the financial plan, and (ii) personality characteristics associated with the customer, where the personality characteristics relate to level of interaction required by the customer and structure of the customer's employees. The computing device is configured to determine a relationship complexity score associated with the customer based upon the financial plan attributes and the personality characteristics. The computing device is configured to determine a target workload value for customer service managers of the financial services entity based upon the relationship complexity score for a plurality of customers and a past number of relationship service hours associated with the plurality of customers, the target workload value representing a level of effort from the financial services entity to provide service to the plurality of customers. The computing device is configured to allocate the customer to a customer service manager based upon the target workload value and a current workload of the customer service manager. The computing device is configured to update an allocation table that contains information relating to the allocation of customers to customer service managers.

The invention, in another aspect, features a computer program product, tangibly embodied in a non-transitory computer readable storage medium, for customer relationship capacity planning by a financial services entity. The computer program product includes instructions that, when executed by a processor of a computing device, cause the computing device to receive (i) financial plan attributes associated with a financial plan of a customer, where the financial plan attributes relate to scope of assets and feature set of the financial plan, and (ii) personality characteristics associated with the customer, where the personality characteristics relate to level of interaction required by the customer and structure of the customer's employees. The computer program product includes instructions that cause the computing device to determine a relationship complexity score associated with the customer based upon the financial plan attributes and the personality characteristics and determine a target workload value for customer service managers of the financial services entity based upon the relationship complexity score for a plurality of customers and a past number of relationship service hours associated with the plurality of customers, the target workload value representing a level of effort from the financial services entity to provide service to the plurality of customers. The computer program product includes instructions that cause the computing device to allocate the customer to a customer service manager based upon the target workload value and a current workload of the customer service manager and update an allocation table that contains information relating to the allocation of customers to customer service managers.

Any of the above aspects can include one or more of the following features. In some embodiments, the step of determining a relationship complexity score further comprises assigning, by the computing device, the customer to a group based upon the financial plan attributes including the scope of assets and the feature set of the financial plan. In some embodiments, the computing device analyzes the financial plan attributes associated with each of the customers in the group to identify similarities among the customers. In some embodiments, the step of determining a relationship complexity score further comprises assigning, by the computing device, a weight value to each of the financial plan attributes and the personality characteristics.

In some embodiments, the past number of relationship service hours is associated with a predetermined service period. In some embodiments, the past number of relationship service hours is divided by the relationship complexity score to arrive at the target workload value. In some embodiments, the step of allocating the customer to a customer service manager further comprises comparing, by the computing device, the current workload of the customer service manager to the target workload value to determine a current capacity of the customer service manager, and allocating, by the computing device, the customer to the customer service manager if the relationship complexity score for the customer is less than or equal to the current capacity of the customer service manager.

In some embodiments, the computing device determines a tolerance associated with the target workload value and allocates the customer to the customer service manager if (i) the relationship complexity score for the customer is greater than the current capacity of the customer service manager and (ii) the difference between the relationship complexity score for the customer and the current capacity of the customer service manager is less than or equal to the tolerance.

In some embodiments, the step of allocating the customer to a customer service manager further comprises determining, by the computing device, a customer satisfaction value for each customer assigned to the customer service manager, and allocating, by the computing device, the customer to the customer service manager if the customer satisfaction value is greater than a predetermined threshold and the current workload of the customer service manager is less than or equal to the target workload value. In some embodiments, the computing device determines a manager performance metric based upon the customer satisfaction value, the relationship complexity score, and the current workload of the customer service manager. In some embodiments, the personality characteristics are based upon survey responses from the customer.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for customer relationship capacity planning by a financial services entity.

FIG. 2 is a flow diagram of a method for customer relationship capacity planning by a financial services entity.

FIG. 3 is a table representing clusters of customer financial plans, grouped according to number of employees enrolled in the plan and assets invested by the employees in the plan.

FIG. 4 is a table representing bins of customer financial plans, sorted according to assets.

FIG. 5A is a table representing scoring variables for certain financial plan attributes associated with a customer's financial plan.

FIG. 5B is a table representing an exemplary financial plan complexity score calculation for a customer's financial plan.

FIG. 6A is a set of tables representing scoring variables for certain personality characteristics associated with a customer.

FIG. 6B is a table representing an exemplary personality characteristics complexity score calculation for a customer.

FIG. 7 is a table representing a list of customers as assigned to particular customer service manager and the customers' associated workload scores.

FIG. 8 is a table representing current workload status and forecast workload status for a list of customer service managers.

FIG. 9 is a diagram depicting a correlation between workload capacity and SAT scores for CSMs to determine how to assign customers.

FIG. 10 is a block diagram of a networked system for customer relationship capacity planning by a financial services entity.

### DETAILED DESCRIPTION

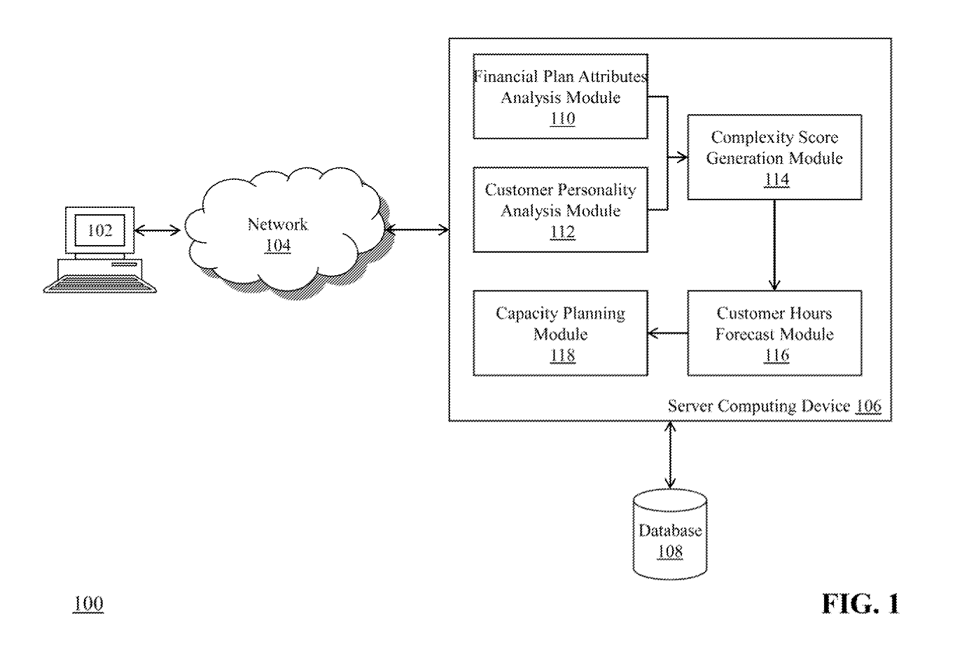

FIG. 1 is a block diagram of a system 100 for customer relationship capacity planning by a financial services entity, according to an embodiment of the invention. The system 100 includes a client device 102, a communications network 104, a server computing device 106 coupled to a database 108, and several modules 110, 112, 114, 116, 118 included in the server computing device 106.

The client device 102 connects to the server computing device 106 via the communications network 104 in order to initiate the customer relationship capacity planning process described herein and receive corresponding results from the server computing device 106. Exemplary client devices include desktop computers, laptop computers, tablets, mobile devices, smartphones, and internet appliances. It should be appreciated that other types of computing devices that are capable of connecting to the server computing device 106 can be used without departing from the scope of invention. Although FIG. 1 depicts a single client device 102, it should be appreciated that the system 100 can include any number of client devices.

The communication network 104 enables the client device 102 to communicate with the server computing device 106 in order to initiate the customer relationship capacity planning process described herein and receive corresponding results from the server computing device 106. The network 104 may be a local network, such as a LAN, or a wide area network, such as the Internet and/or a cellular network. In some embodiments, the network 104 is comprised of several discrete networks and/or sub-networks (e.g., cellular to Internet) that enable the client device 102 to communicate with the server computing device 106.

The server computing device 106 is a combination of hardware and software modules that perform the customer relationship capacity planning process and transmit the results of the customer relationship capacity planning to remote computing devices (e.g., device 102). The server computing device 106 includes a financial plan attributes analysis module 110, a customer personality analysis module 112, a complexity score generation module 114, a customer hours forecast module 116, and a capacity planning module 118. The modules 110, 112, 114, 116, 118 are hardware and/or software modules that reside on the server computing device 106 to perform functions associated with the customer relationship capacity planning process described herein. In some embodiments, the functionality of the modules 110, 112, 114, 116, 118 is distributed among a plurality of computing devices. It should be appreciated that any number of computing devices, arranged in a variety of architectures, resources, and configurations (e.g., cluster computing, virtual computing, cloud computing) can be used without departing from the scope of the invention. It should also be appreciated that, in some embodiments, the functionality of the modules 110, 112, 114, 116, 118 can be distributed such that any of the modules 110, 112, 114, 116, 118 are capable of performing any of the functions described herein without departing from the scope of the invention. For example, in some embodiments, the functionality of the modules 110, 112, 114, 116, 118 can be merged into a single module. The exemplary functionality of each module 110, 112, 114, 116, 118 will be described in greater detail below.

The system 100 also includes a database 108. The database 108 is coupled to the server computing device 106 and stores data used by the server computing device 106 to perform the customer relationship capacity planning functionality. The database 108 can be integrated with the server computing device 106 or be located on a separate computing device. An example database that can be used with the system 100 is MySQL™ available from Oracle Corp. of Redwood City, Calif.

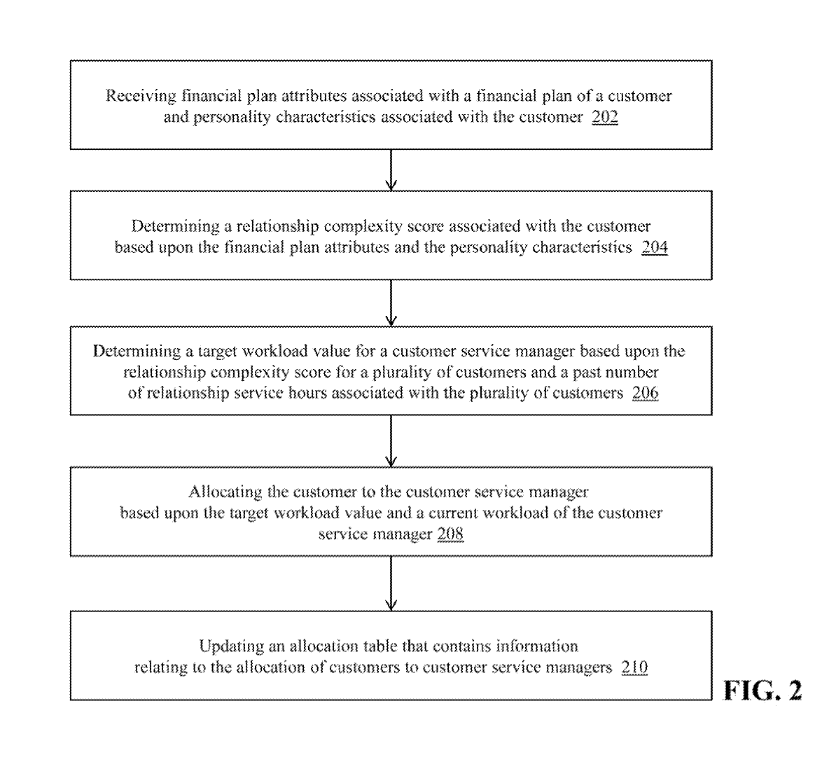

FIG. 2 is a flow diagram of a method for customer relationship capacity planning by a financial services entity, using the system 100 of FIG. 1. The financial plan attributes analysis module 110 receives (202) financial plan attributes associated with a financial plan of a customer. The customer may be a corporation or other entity that receives financial and/or business services from a financial services company that operates the system 100. For example, the financial services company may manage the customer's 401(k) savings plan for the customer's employees. In another example, the financial services company may provide a flexible spending account for the customer's employees.

It should be appreciated that, while the present disclosure describes the systems and methods in the context of a relationship between a customer and a financial services entity, the concepts described herein are equally applicable to a variety of different contexts and relationships without departing from the scope of invention. For example, the financial services entity may be an insurance company that provides insurance services to the customer and/or its employees. In another example, the customer may be an individual client of the financial services company that holds one or more accounts (e.g., brokerage, investment, trust, and the like) with the financial services company. In yet another example, the customer may be a manufacturer of goods that receives raw materials and parts from a supplier entity, and the supplier wishes to determine a complexity and related workload of its relationship with the manufacturer.

Turning back to the previous example, the financial plan attributes analysis module 110 can receive a wide variety of financial plan attributes associated with a financial plan of a customer. The financial plan attributes can include data about the structure of the financial plan, service features relating to the financial plan, amount and type of assets held within the financial plan, investment features and options available in the financial plan, and other similar attributes. For example, where the financial plan is a 401(k) savings plan, the plan attributes can include the number and identity of distinct funds within the plan, the total amount of dollars invested in the plan by a customer's employees, the allocation of the invested dollars (i.e., in which funds or asset classes), certain service features of the plan (e.g., auto enrollment, catch-up provisions, Roth IRA availability, company stock purchasing, auto rebalancing, hardship withdrawal), and the like.

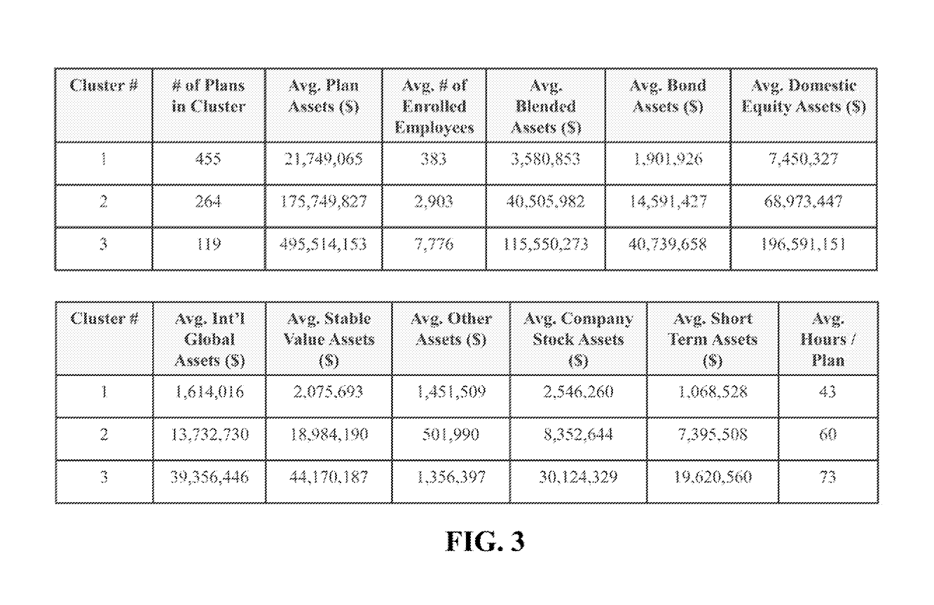

The financial plan attributes analysis module 110 analyzes the received financial plan attributes for individual customers (i.e., as part of the complexity score determination) as well as an aggregate of customers (i.e., to determine similarities and differences between the financial plans of groups of customers). FIG. 3 is a table representing clusters of customer financial plans, grouped according to number of employees enrolled in the plan and assets invested by the employees in the plan, as generated by the financial plan attributes analysis module 110. As shown in FIG. 3, the financial plan attributes analysis module 110 has grouped all of the customer financial plans that are serviced by the financial services entity into clusters (represented by the Cluster # column). Each cluster contains a number of customer financial plans, and certain attributes of the plans within each cluster are averaged to determine differences.

For example, Cluster #1 includes 455 plans that have an average asset value of $21,749,065, an average number of enrolled employees of 383, and an average number of customer relationship service hours per plan per year of 43, among other data points. Cluster #2 has fewer plans than Cluster #1 but has a greater average asset value, average number of enrolled employees, and hours per plan, while Cluster #3 again has fewer plans than Cluster #2 but a greater average asset value, average number of enrolled employees, and hours per plan. Therefore, the data evinces that plans with a higher asset value and number of enrolled employees require a greater number of customer relationship service hours per year than plans with lower values in those categories.

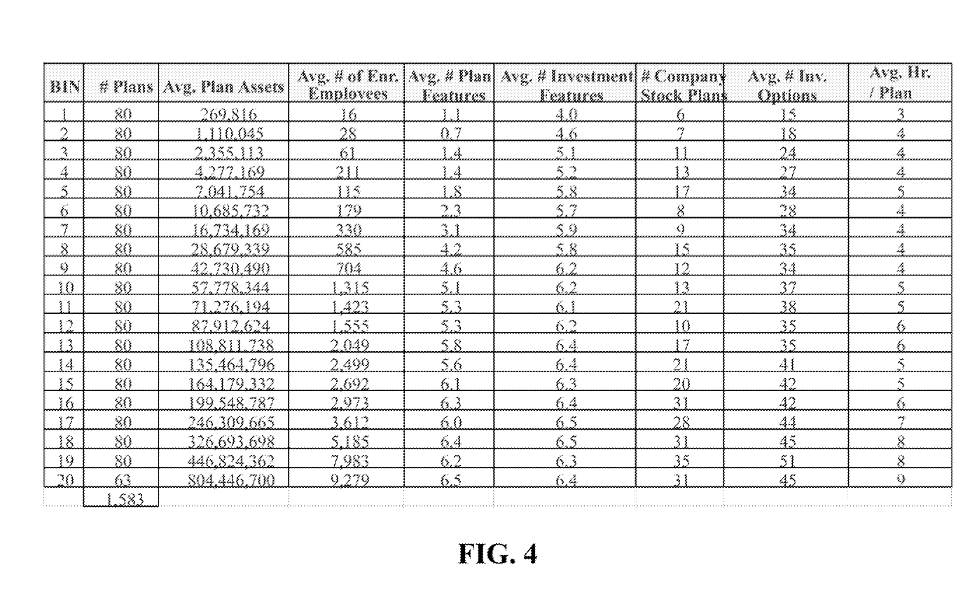

FIG. 4 is a table representing bins of customer financial plans, sorted according to assets, as generated by the financial plan attributes analysis module 110. As shown in FIG. 4, each of the 1,583 plans is sorted according to plan assets and separated into bins of 80 or fewer plans (e.g., Bin 1 includes the 80 plans that have the lowest plan asset value). As can be observed in the table, the average plan assets and average number of enrolled employees generally increases from Bin 1 to 20. The other categories (average number of plan features, average number of investment features, number of company stock plans, and average number of investment options) also generally increase from Bin 1 to 20. Finally, the average number of hours per plan increases in a similar fashion from Bin 1 to 20—indicating that plans with a higher asset value and number of enrolled employees typically require a higher number of customer relationship service hours than plans with a lower asset value and number of enrolled employees.

Turning back to FIG. 2, the customer personality analysis module 112 receives (202) personality characteristics associated with the customer, aggregates the characteristics, and analyzes the characteristics. Generally, the personality characteristics for a customer relate to the structure and complexity of the customer's employees and operations, as well as the customer's service preferences and interactions between the customer and the CSM at the financial services entity. For example, a customer may be a corporation that is comprised of four different divisions with twelve sub-groups (thereby increasing the potential for a complex customer service relationship). Other considerations can include, but are not limited to: the structure of any employee unions at the customer, the number of payroll feeds at the customer, the number of health savings accounts at the customer, whether the customer's plan has an employee stock option plan or outside trustee stock, and the like.

In another example, a customer may require a certain level of interaction from the CSM, such as site visits, calls, ad-hoc reports, and so forth. For example, a customer may require a CSM to make seven annual site visits to the customer's location, and/or make twenty-four service calls to the customer over a twelve-month period. In some embodiments, at least some of the personality characteristics can be provided by the customer via a survey, questionnaire or other submission. An increase in the level of interaction required can result in a more complex customer service relationship between the customer and the CSM/financial services entity.

Once the financial plan attributes analysis module 110 and the customer personality analysis module 112 have collected and processed the respective data points, the complexity score generation module 114 receives the data from modules 110 and 112. The complexity score generation module 114 uses the data to determine (204) a relationship complexity score associated with the customer based upon the financial plan attribute data and the personality characteristics data. In one embodiment, the relationship complexity score is a numeric value that represents a level of service complexity assigned to the relationship between the customer and the CSM/financial services entity. For example, a customer with a higher relationship complexity score can be considered to have a more complex relationship that may require a greater amount of customer service time and effort than a customer with a lower complexity score.

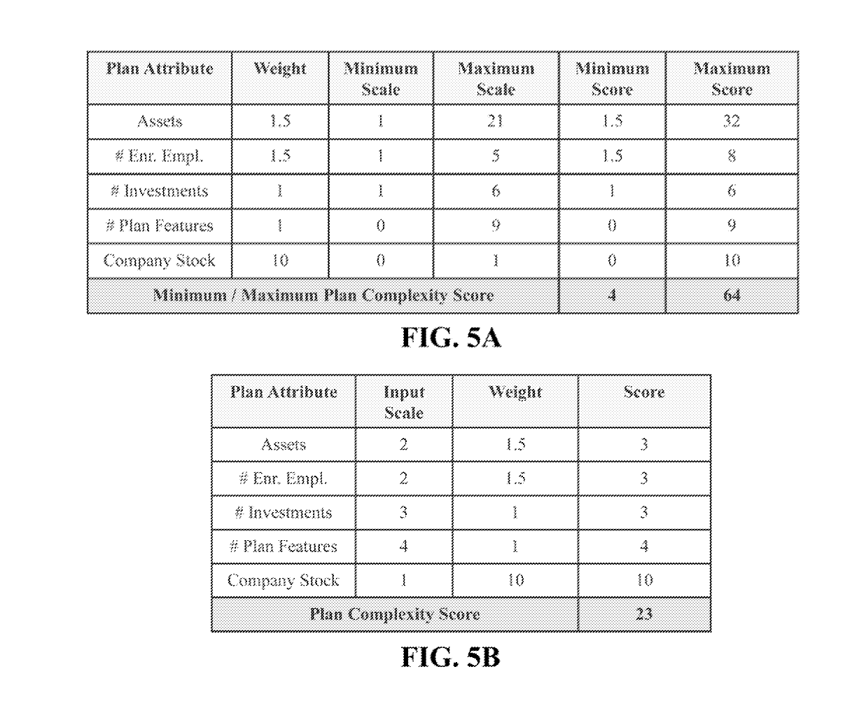

The complexity score generation module 114 determines the relationship complexity score by analyzing the financial plan attributes and the personality characteristics in a weighted scoring algorithm. Beginning with the financial plan attributes, FIG. 5A is a table representing complexity scoring variables for certain financial plan attributes associated with a customer's financial plan. As shown in FIG. 5A, each of the following categories is assigned a weight, a minimum scale, a maximum scale, a minimum score, and a maximum score. The minimum scale and maximum scale are statistically-generated values to approximate the range of underlying values that are attributed to the particular attributes—the minimum and maximum range do not necessarily correspond to the actual underlying values. The weight is applied to the minimum scale and the maximum scale to arrive at the minimum score and maximum score. For example, for the assets attribute, the weight is 1.5, the minimum scale is 1 and the maximum scale is 21—therefore, the minimum plan complexity score for a given customer is 1.5 (i.e., 1×1.5) and the maximum plan complexity score is 32 (i.e., 21×1.5).

FIG. 5B is a table representing an exemplary financial plan complexity score calculation for a customer's financial plan. As shown in FIG. 5B, the complexity score generation module 114 assigns input values based upon a company's financial plan. For example, the module 114 assigns an input scale value of 2 to the assets attribute for a company's financial plan, an input scale value of 2 to the number of enrolled employees attribute for a company's financial plan, an input scale value of 3 to the number of investments attribute for a company's financial plan, an input scale value of 4 to the number of plan features attribute for a company's financial plan, and an input scale of 1 to the company stock attribute for a company's financial plan. The module 114 applies the weight to each attribute to determine the plan complexity score—resulting in a total plan complexity score of 23, as shown in FIG. 5B.

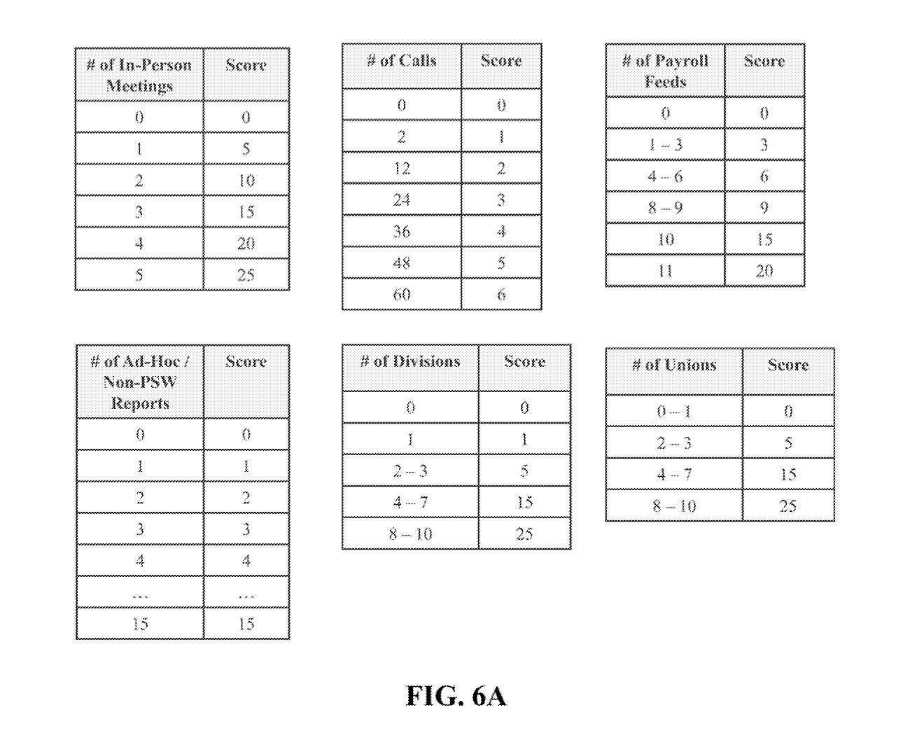

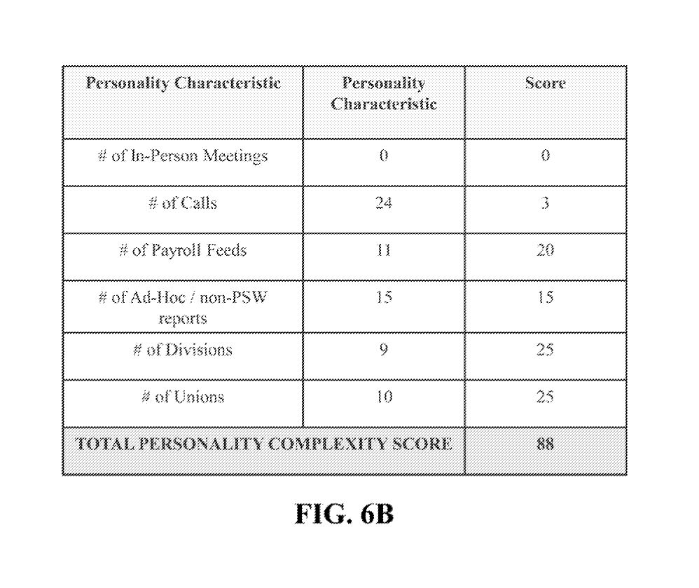

The complexity score generation module 114 then analyzes the personality characteristics data for the customer to determine a customer personality complexity score. FIG. 6A is a set of tables representing scoring variables for certain personality characteristics associated with a customer. As shown in FIG. 6A, the personality characteristics include, but are not limited to: number of in-person meetings, number of payroll feeds (e.g., number of locations where payroll feeds come from), number of calls, number of ad-hoc/non-PSW reports, number of divisions, and number of unions. For each characteristic, the module 114 assigns a score value that corresponds to the actual value for that characteristic. For example, if a customer requires four in-person meetings within a given time period (e.g., one year), the module 114 assigns a score of 20 to the number of in-person meetings characteristic. It should be appreciated that the score values can correspond to a scale of statistically-generated values to approximate the range of underlying values that are attributed to the particular characteristics and do not necessarily have to correspond to the actual underlying values.

FIG. 6B is a table representing an exemplary personality characteristics complexity score calculation for a customer. The personality characteristic value for the customer is compared to the corresponding scoring variable table in FIG. 6A to determine a score for each personality characteristic. For example, as shown in FIG. 6B, the customer required zero in-person meetings, resulting in a score of zero for that characteristic. However, the customer required 24 service calls, resulting in a score of 3 for that characteristic. The total personality characteristic complexity score for the customer is 88.

Once the complexity score generation module 114 has determined the plan complexity score and the personality complexity score, the module 114 determines that the overall relationship complexity score for the customer (using the example in FIGS. 5B and 6B above) is 88+23=111. The module 114 stores the relationship complexity score for the customer in database 108.

The customer hours forecast module 116 determines (206) a target workload value (also called a target book size) for a customer relationship manager of the financial services entity based upon the relationship complexity scores for a plurality of customers and a past number of relationship service hours associated with the customers. The target workload value represents an approximate or a target amount of work that can be assigned to each customer relationship manager of the financial services entity.

For example, the financial services entity may track the number of hours during a previous time period (e.g., one year) that its CSMs spent in providing customer service to all of the customers. The module 116 can then use the number of past hours in conjunction with the relationship complexity scores for all of the customers to arrive at a target workload value for each customer relationship manager. One example of a calculation to determine the target workload value is as follows: total number of hours spent by CSMs in providing service to a particular set of customers for a given prior period divided by the relationship complexity scores for the set of customers. If, for example, fifty CSMs at the financial services entity spent a total of 90,000 hours providing customer service to and managing relationships with financial services customers during the prior year and the cumulative relationship complexity scores for all of the customers is 34,615, then the module 116 determines that the number of hours spent per point of relationship complexity score is 2.6, or 90,000/34,615. Next, the module 116 determines that, assuming each CSM is allotted 1,800 working hours per year, the target workload value for each CSM is 692 points, or 1,800 hours/2.6 hours per point. This means that the system 100 can assign customers to each CSM with cumulative relationship complexity scores up to the 692-point target workload value.

In this respect, the allocation of customers to CSMs is dynamic and flexible because each CSM can have a balance of higher complexity and lower complexity customers, and the system 100 can determine whether a particular CSM is more suited to handling higher complexity customers. For example, the financial services entity may recognize that a first CSM is skilled at handling very complex customer relationships while a second CSM is better at handling less complex relationships. The system 100 can allocate customers with high relationship complexity scores to the first CSM and allocate customers with lower complexity scores to the second CSM. The end result is that the first CSM handles a fewer number of customers than the second CSM, but the first CSM's customer relationships are more complex than the second CSM's relationships. In addition, incoming and potential customers can be allocated to CSMs using this methodology so that the present workload and anticipated future workload is consistently and appropriately balanced among the CSMs.

In some optional embodiments, however, the complexity score generation module 114 can transfer the overall relationship complexity score directly to the capacity planning module 118 without the customer hours forecast module 116 first determining a target workload value. Instead, the capacity planning module 118 can determine the target workload value and/or retrieve a predetermined target workload value from a database.

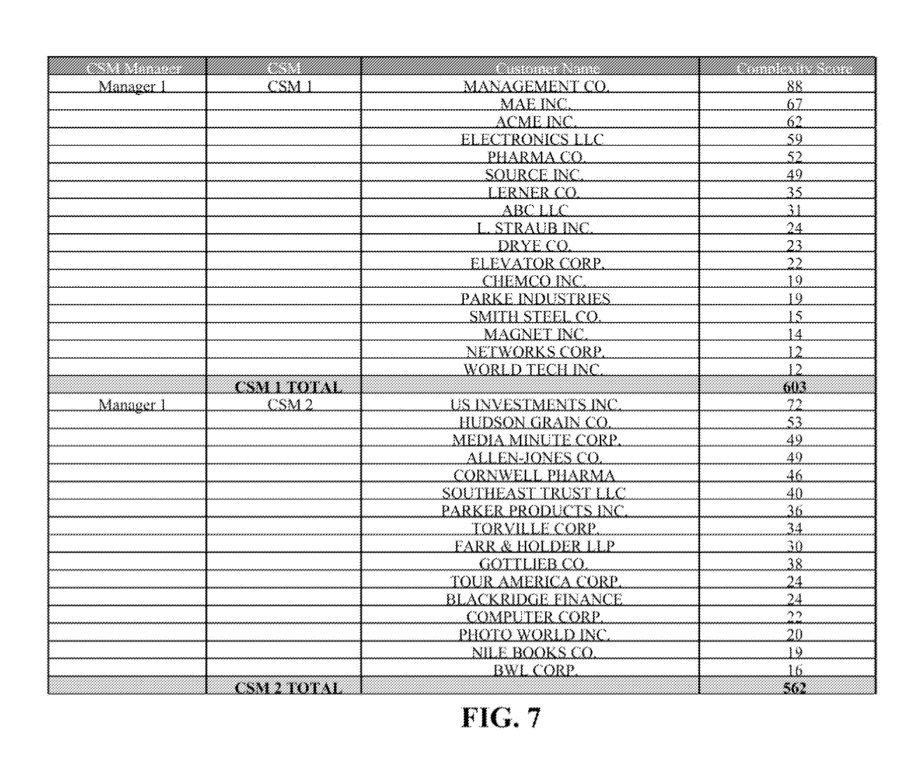

Once the target workload value is determined, the capacity planning module 118 of the computing device 106 allocates (208) the customer to a customer relationship manager based upon the target workload value (e.g., 692 points) and a current capacity of the customer relationship manager to assume additional work. FIG. 7 is a table representing a list of customers as assigned to customer service managers and the customers' associated relationship complexity scores. The workloads for two CSMs (CSM 1 and CSM 2) are shown in FIG. 7, including a list of each customer assigned to the respective CSMs and the customer's associated complexity score. For example, customer Acme Inc. is allocated to CSM 1 and has a complexity score of 62. For each CSM, the total current workload is represented by the total complexity score for all of that CSM's customers. For example, CSM 1 has a current workload of 603, while CSM 2 has a current workload of 562. The module 118 analyzes the current workload of each CSM and compares the current workload to the target workload value to determine the CSM's capacity to assume additional customers. Continuing with the previous example, the target workload value is 692 and CSM 1's current workload is 603. As a result, CSM 1 has a capacity of 89 points (692−603) and the module 118 can allocate one or more customers to CSM 1 that have a cumulative relationship complexity score of 89 or lower.

In some cases, the module 118 can allocate customers to CSMs that result in the CSM's current workload to exceed the target workload value, within a tolerance level. For example, the module 118 can be configured to allow a tolerance of 25 points over the target workload value. Therefore, if a CSM has a current workload of 672 and a new customer has a relationship complexity score of 45, the module 118 can still assign that customer to the CSM even though it would result in the CSM having a current workload of 717—because the current workload only exceeds the target workload value by 25 points.

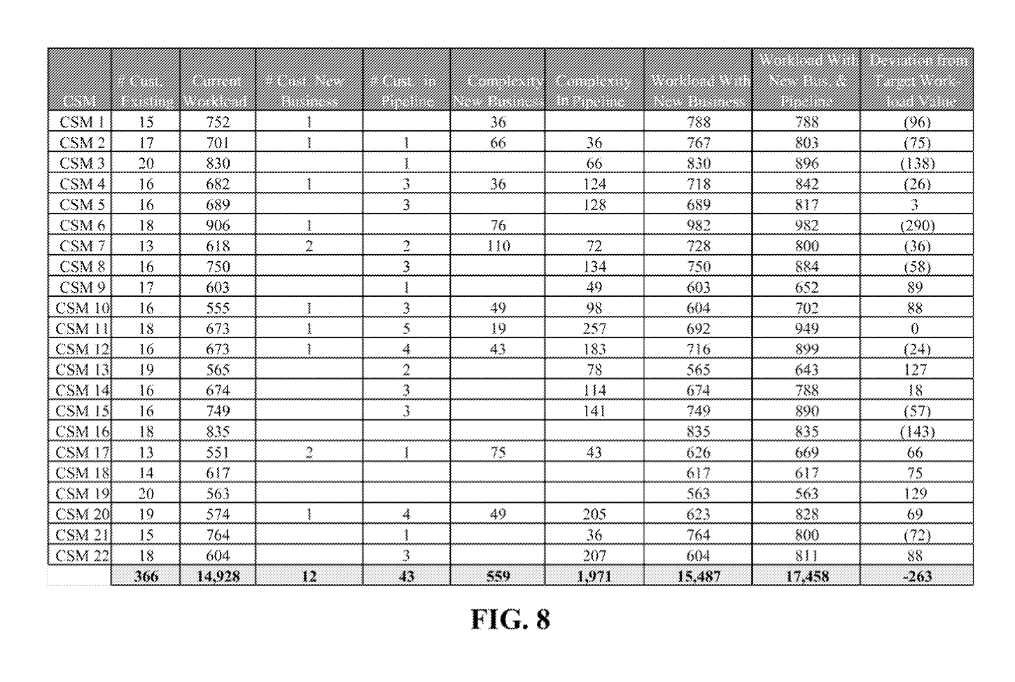

As mentioned above, the capacity planning module 118 also forecasts CSM workloads for potential and newly-acquired customers. FIG. 8 is a table representing current workload status and forecast workload status for a list of customer service managers. Each CSM is listed along with the number of existing customers allocated to the CSM, the CSM's current workload, the number of new-business customers allocated to the CSM, the number of pipeline (or potential) customers allocated to the CSM, the corresponding relationship complexity score for the new-business and pipeline customers, the CSM's forecast workload with the new-business and pipeline customers added, and the deviation of the CSM's workload from the target workload value. For example, CSM 1 has 15 currently-allocated customers with a total relationship complexity score of 752. The module 118 has allocated one new-business customer and zero pipeline customers to CSM 1. The new-business customer has a relationship complexity score of 36. Adding the new-business customer, the total relationship complexity score (or workload) for CSM 1 is 788 (752+36). Therefore, CSM 1's workload exceeds the target workload value by 96 points (788−692).

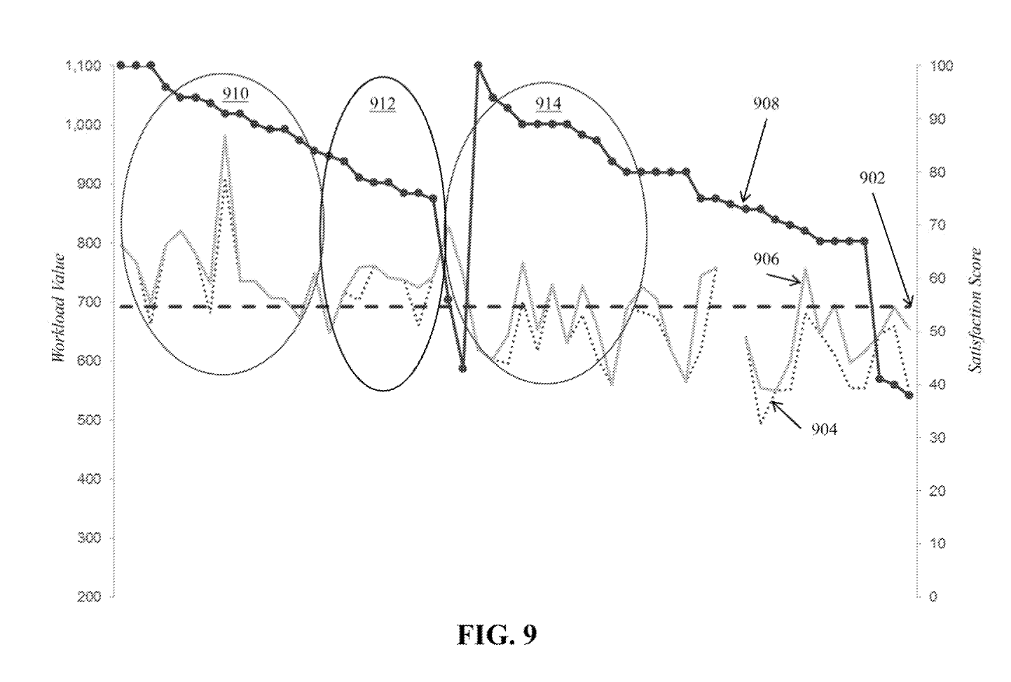

In some embodiments, the system 100 can incorporate additional metrics about the customer relationships when determining the allocation of customers to customer service managers. For example, the financial services entity can collect feedback from its customers about their satisfaction with the customer service. The system 100 converts the feedback into a satisfaction score (SAT) and stores the satisfaction score in the database 108 in association with the customer. The system 100 can then determine, for a particular CSM, whether the allocated customers have a high or low cumulative (or average) SAT score—thereby indirectly indicating the performance level of the CSM. FIG. 9 is a diagram depicting a correlation between workload capacity and satisfaction scores for CSMs to determine how to assign customers. As shown in FIG. 9, the dashed line 902 represents the target workload value (692) for the CSMs, the dotted line 904 represents the current workload for the CSMs, the solid gray line 906 represents the current workload plus pipeline customers for the CSMs, and the solid-with-dots line 908 represents the satisfaction score for the CSMs.

The circle 910 indicates a set of CSMs that generally have a higher current workload (and current plus pipeline workload) than the target workload score. However, these CSMs also have a high satisfaction score. Therefore, the system 100 determines that these CSMs are currently handling a greater number and/or more complex customers than other CSMs and are doing so in a way that resulted in high satisfaction from the customers—potentially representing CSMs that have achieved a high level of success. In contrast, the circle 912 indicates a set of CSMs that generally have a higher current workload than the target workload score but have a lower SAT score—potentially representing CSMs that are underachieving or are not providing quality service to customers.

In addition, the circle 914 indicates a set of CSMs that have a high satisfaction score and also have a current workload that is lower than the target workload value. Therefore, the system 100 determines that these CSMs may be preferred for purposes of allocating new and pipeline customers because (i) they have the capacity to take on additional relationships and (ii) their current customers have been satisfied with the service received.

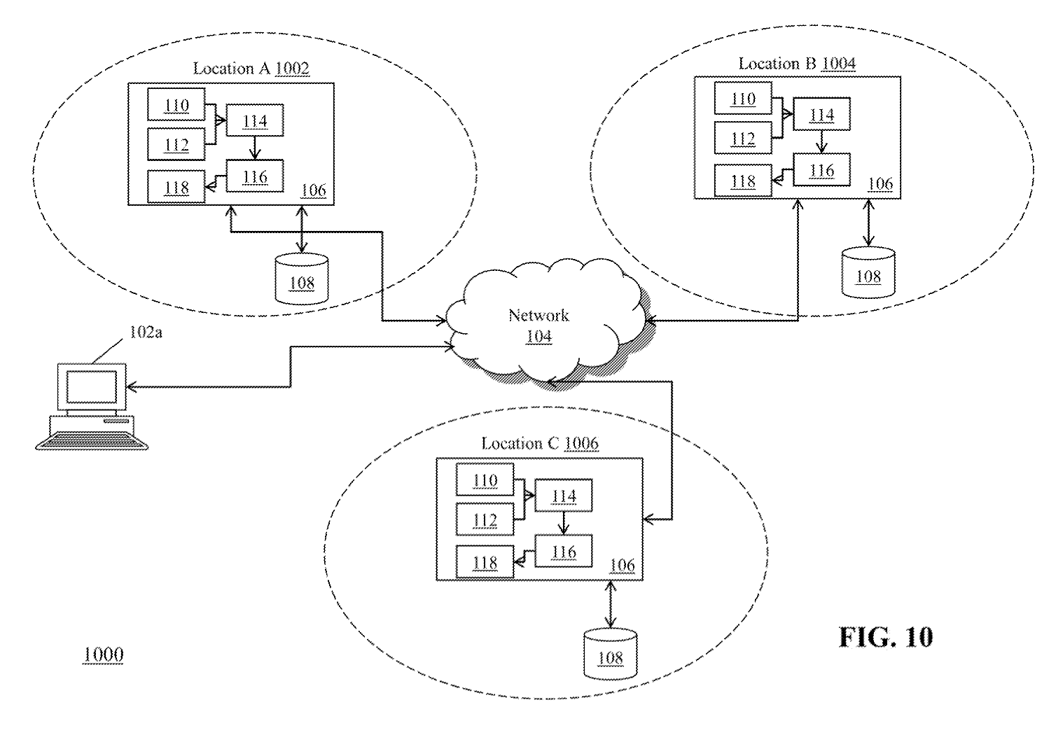

The methods, systems and techniques described herein may be implemented in a networked system 1000 comprising multiple computing devices distributed across different locations, as shown in FIG. 10. Each of Location A 1002, Location B 1004 and Location C 1006 includes the server computing device 106 having components 108, 110, 112, 114, 116, 118 of FIG. 1, and the servers at locations 1002, 1004, 1006 are connected to each other via the network 104. The networked system of FIG. 10 enables distribution of the processing functions described herein across several computing devices and provides redundancy in the event that a computing device at one location is offline or inoperable. In some embodiments, client computing devices (e.g., device 102) in proximity to a particular location (e.g., Location A 1002) access the networked system via the server 106 at that location. In some embodiments, the server computing devices 106 at the respective locations 1002, 1004, 1006 communicate with a central computing device 1008 (e.g., a server) that is coupled to the network.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein.

1. A computerized method for customer relationship capacity planning by a financial services entity, the method comprising:
receiving, by a computing device, (i) financial plan attribute data associated with a financial plan of each of a plurality of potential customers and a plurality of newly-acquired customers, wherein the financial plan attribute data relates to scope of assets and feature set of the financial plan, and (ii) personality characteristic data associated with the customer, wherein the personality characteristic data relates to a level of interaction requested by the customer and a structure of the customer's employees;
aggregating, by the computing device, the financial plan attribute data for the plurality of potential customers and the plurality of newly-acquired customers into a binned memory structure comprising a plurality of bin storage locations, wherein the plurality of potential customers and the plurality of newly-acquired customers are grouped by at least a financial plan asset value before being allocated to a bin storage location and wherein each bin storage location contains data for customers with similar financial plan asset values;
assigning, by the computing device, an average number of hours spent in a previous time period to service existing customers having similar financial plan attribute data to the financial plan attribute data for the customers in the binned memory structure;
determining, by the computing device, a relationship complexity score associated with each of the potential customers and the plurality of newly-acquired customers based upon the financial plan attribute data, the personality characteristic data for each customer, and the average number of hours assigned to the customer's bin storage location;
determining, by the computing device, a current workload value for a customer service manager of the financial services entity based upon the relationship complexity scores for each of a plurality of existing customers already allocated to the customer service manager, the current workload value representing a level of effort from the customer service manager to provide service to the plurality of existing customers already allocated to the customer service manager;
determining, by the computing device, a target workload value for the customer service manager based upon relationship complexity scores for each of the existing customers of the financial services entity and a past number of relationship service hours spent in a previous time period to service each of the existing customers;
allocating, by the computing device, a portion of the potential customers and the newly-acquired customers to the customer service manager based upon the current workload value and the target workload value for the customer service manager, including
determining, by the computing device, a customer satisfaction value for each existing customer already assigned to the customer service manager,
aggregating, by the computing device, the customer satisfaction value for each existing customer into a customer satisfaction score for the customer service manager,
displaying, by the computing device, a graph of a comparison between current workload values for a plurality of customer service managers and customer satisfaction scores for the plurality of customer service managers including placing one or more visual indicators on the graph to isolate data points corresponding to one or more customer service managers that have a customer satisfaction score greater than a predetermined threshold and a current workload value that is less than or equal to the target workload value, and
allocating, by the computing device, the portion of the potential customers and the newly-acquired customers to the customer service manager if the data point corresponding to the customer service manager is within one of the visual indicators on the graph; and
updating, by the computing device, an allocation table that contains information relating to the allocation of customers to customer service managers.

2. The method of claim 1, wherein the step of determining a relationship complexity score further comprises assigning, by the computing device, the customer to a cluster based upon the financial plan attribute data including the scope of assets and the feature set of the financial plan.

3. The method of claim 2, further comprising analyzing, by the computing device, the financial plan attribute data associated with each of the customers in the cluster to identify similarities among the customers.

4. The method of claim 1, wherein the step of determining a relationship complexity score further comprises assigning, by the computing device, a weight value to each of the financial plan attribute data and the personality characteristic data.

5. The method of claim 1, wherein the past number of relationship service hours is associated with a predetermined service period.

6-7. (canceled)

8. The method of claim 1, further comprising:
determining, by the computing device, a tolerance associated with the target workload value; and
allocating, by the computing device, the portion of the potential customers and the newly-acquired customers to the customer service manager if (i) the relationship complexity scores for the portion of the potential customers and the newly-acquired customers are greater than the difference between the current workload value for the customer service manager and the target workload value for the customer service manager and (ii) the difference between the current workload value for the customer service manager and the target workload value for the customer service manager is less than or equal to the tolerance.

9. (canceled)

10. The method of claim 1, further comprising determining, by the computing device, a manager performance metric based upon the customer satisfaction score for the customer service manager, the target workload value for the customer service manager, and the current workload value for the customer service manager.

11. The method of claim 1, wherein the personality characteristic data is based upon survey responses from the customer.

12. A system for customer relationship capacity planning by a financial services entity, the system comprising a computing device configured to:
receive (i) financial plan attributes associated with a financial plan of each of a plurality of potential customers and a plurality of newly-acquired customers, wherein the financial plan attributes relate to scope of assets and feature set of the financial plan, and (ii) personality characteristics associated with the customer, wherein the personality characteristics relate to a level of interaction requested by the customer and a structure of the customer's employees;
aggregate the financial plan attribute data for the plurality of potential customers and the plurality of newly-acquired customers into a binned memory structure comprising a plurality of bin storage locations, wherein the plurality of potential customers and the plurality of newly-acquired customers are grouped by at least a financial plan asset value before being allocated to a bin storage location and wherein each bin storage location contains data for customers with similar financial plan asset values;
assign an average number of hours spent in a previous time period to service existing customers having similar financial plan attribute data to the financial plan attribute data for the customers in the binned memory structure;
determine a relationship complexity score associated with each of the potential customers and the plurality of newly-acquired customers based upon the financial plan attribute data, the personality characteristic data for each customer, and the average number of hours assigned to the customer's bin storage location;
determine a current workload value for a customer service manager of the financial services entity based upon the relationship complexity scores for each of a plurality of existing customers already allocated to the customer service manager, the current workload value representing a level of effort from the customer service manager to provide service to the plurality of existing customers already allocated to the customer service manager;
determine a target workload value for the customer service manager based upon relationship complexity scores for each of the existing customers of the financial services entity and a past number of relationship service hours spent in a previous time period to service each of the existing customers;
allocate a portion of the potential customers and the newly-acquired customers to the customer service manager based upon the current workload value and the target workload value for the customer service manager, including
determining a customer satisfaction value for each existing customer already assigned to the customer service manager,
aggregating the customer satisfaction value for each existing customer into a customer satisfaction score for the customer service manager,
displaying a graph of a comparison between current workload values for a plurality of customer service managers and customer satisfaction scores for the plurality of customer service managers including placing one or more visual indicators on the graph to isolate data points corresponding to one or more customer service managers that have a customer satisfaction score greater than a predetermined threshold and a current workload value that is less than or equal to the target workload value, and
allocating the portion of the potential customers and the newly-acquired customers to the customer service manager if the data point corresponding to the customer service manager is within one of the visual indicators on the graph; and
update an allocation table that contains information relating to the allocation of customers to customer service managers.

13. The system of claim 12, wherein the step of determining a relationship complexity score further comprises assigning the customer to a cluster based upon the financial plan attribute data including the scope of assets and the feature set of the financial plan.

14. The system of claim 13, further comprising analyzing the financial plan attribute data associated with each of the customers in the cluster to identify similarities among the customers.

15. The system of claim 12, wherein the step of determining a relationship complexity score further comprises assigning a weight value to each of the financial plan attribute data and the personality characteristic data.

16. The system of claim 12, wherein the past number of relationship service hours is associated with a predetermined service period.

17-18. (canceled)

19. The system of claim 12, further comprising:
determining a tolerance associated with the target workload value; and
allocating the portion of the potential customers and the newly-acquired customers to the customer service manager if (i) the relationship complexity scores for the portion of the potential customers and the newly-acquired customers are greater than the difference between the current workload value for the customer service manager and the target workload value for the customer service manager and (ii) the difference between the current workload value for the customer service manager and the target workload value for the customer service manager is less than or equal to the tolerance.

20. (canceled)

21. The system of claim 12, further comprising determining a manager performance metric based upon the customer satisfaction score for the customer service manager, the target workload value for the customer service manager, and the current workload value for the customer service manager.

22. The system of claim 12, wherein the personality characteristic data is based upon survey responses from the customer.

23. A computer program product, tangibly embodied in a non-transitory computer readable storage medium, for customer relationship capacity planning by a financial services entity, the computer program product including instructions that, when executed by a processor of a computing device, cause the computing device to:
receive (i) financial plan attributes associated with a financial plan of each of a plurality of potential customers and a plurality of newly-acquired customers, wherein the financial plan attributes relate to scope of assets and feature set of the financial plan, and (ii) personality characteristics associated with the customer, wherein the personality characteristics relate to a level of interaction requested by the customer and a structure of the customer's employees;
aggregate the financial plan attribute data for the plurality of potential customers and the plurality of newly-acquired customers into a binned memory structure comprising a plurality of bin storage locations, wherein the plurality of potential customers and the plurality of newly-acquired customers are grouped by at least a financial plan asset value before being allocated to a bin storage location and wherein each bin storage location contains data for customers with similar financial plan asset values;
assign an average number of hours spent in a previous time period to service existing customers having similar financial plan attribute data to the financial plan attribute data for the customers in the binned memory structure;
determine a relationship complexity score associated with each of the potential customers and the plurality of newly-acquired customers based upon the financial plan attribute data, the personality characteristic data for each customer, and the average number of hours assigned to the customer's bin storage location;
determine a current workload value for a customer service manager of the financial services entity based upon the relationship complexity scores for each of a plurality of existing customers already allocated to the customer service manager, the current workload value representing a level of effort from the customer service manager to provide service to the plurality of existing customers already allocated to the customer service manager;
determine a target workload value for the customer service manager based upon relationship complexity scores for each of the existing customers of the financial services entity and a past number of relationship service hours spent in a previous time period to service each of the existing customers;
allocate a portion of the potential customers and the newly-acquired customers to the customer service manager based upon the current workload value and the target workload value for the customer service manager, including
determining a customer satisfaction value for each existing customer already assigned to the customer service manager,
aggregating the customer satisfaction value for each existing customer into a customer satisfaction score for the customer service manager,
displaying a graph of a comparison between current workload values for a plurality of customer service managers and customer satisfaction scores for the plurality of customer service managers including placing one or more visual indicators on the graph to isolate data points corresponding to one or more customer service managers that have a customer satisfaction score greater than a predetermined threshold and a current workload value that is less than or equal to the target workload value, and
allocating the portion of the potential customers and the newly-acquired customers to the customer service manager if the data point corresponding to the customer service manager is within one of the visual indicators on the graph; and
update an allocation table that contains information relating to the allocation of customers to customer service managers.
